(19) United States
(12) Patent Application Publication
(10) Pub. No.: US 2010/0147623 A1
(43) Pub. Date: Jun. 17, 2010

(54) LADDER STABILIZATION SYSTEM

(76) Inventor: KEVIN L. POCOS, Avon, OH (US)

Correspondence Address: Kevin Pocos, 36891 Kinzel Rd., Avon, OH, 44011, US

(21) Appl. No.: 12/337,558

(22) Filed: Dec. 17, 2008

(51) Int. Cl. E06C 7/10

(52) U.S. Cl. 182/107; 102/200

(57) ABSTRACT

A ladder anchor and method for applying a stabilizing force on a ladder propped up against a structure in a climbing orientation is disclosed. The ladder anchor includes a base member to be coupled to a mounting surface and one or more adjustable braces extending between the ladder anchor and the ladder. The base member also includes at least one receiver for receiving an instantaneously-actuated fastener to instantaneously secure the base member to the mounting surface. An adjustment apparatus is provided to allow rapid, fine, or both rapid and fine adjustment of the length of at least one of the braces to thereby apply the stabilizing force on to the ladder and minimize slippage of the bottom portion of the ladder away from the structure that the ladder is propped up against while in the climbing orientation.

### BACKGROUND OF THE INVENTION

1. Field of the Invention

The present invention is directed generally to a ladder stabilization system, and more particularly to rapidly-deployable ladder anchor for stabilizing a ladder adjacent to a structure.

2. Description of Related Art

Traditionally, firefighters and others who need to gain access to elevated locations such as the second floor of a building or other structure have relied on straight ladders propped up against the building. One end of the ladder, a base, is rested on the ground, spaced away from the base of the building. The other end is placed up against a vertical wall of the building so as to form the hypotenuse of a triangle formed by the wall of the building, the ground, and the ladder itself. With the ladder so positioned, firefighters can climb the rungs of the ladder to gain access to the second floor from outside of the building.

When a firefighter climbs the rungs of a ladder positioned against a vertical wall of a building in this manner, a force is exerted on the base of the ladder. Such a force includes a component that urges the base away from the wall against which the ladder is propped. If this force exceeds a threshold magnitude, the base of the ladder can slide away from the wall, causing the ladder and the firefighter to fall to the ground and exposing the firefighter to injury.

In order to minimize the risk of such injuries, firefighters have come to adopt a practice of “anchoring” the base of the ladder adjacent to the bottom of the wall against which the ladder is to be rested. The most commonly used anchoring technique requires the firefighters to tie one end of a rope to the ladder at a location near the base, and the other end of the rope to a stationary object. A second rope is similarly tied between the other lateral side of the ladder and another stationary object. The tension in the ropes pulls the ladder in each lateral direction, thereby preventing the ladder from moving in either direction. Further, if the ropes are properly tied such that they also extend generally toward the bottom of the wall, they can urge the bottom of the ladder towards the wall to minimize the chances of the base of the ladder from sliding away from the wall.

In the event of a fire, however, time is of the essence. As a rule of thumb during the early stages of a fire, the size of the fire doubles every minute that a fire is allowed to burn without efforts to extinguish it. The time it takes to properly tie the ropes to stabilize the ladder can allow the fire to burn uncontrolled long enough to cause significant damage to property and expose those inside the burning building to injury. Further, if the ladder needs to be moved to a new location both ropes must first be untied from the stationary objects and then retied once the ladder has been moved, introducing additional delay when time is critical.

Accordingly, there is a need in the art for a ladder stabilizing system that stabilizes a ladder to minimize the likelihood of a base of the ladder slipping away from a structure against which the ladder is rested. Such a ladder stabilizing system can also be rapidly deployed, and can optionally provide lateral stabilization as well.

### BRIEF SUMMARY OF THE INVENTION

According to one aspect, the present invention provides a ladder anchor for applying a stabilizing force on a ladder propped up against a structure in a climbing orientation. The ladder anchor includes a base member to be coupled to a mounting surface adjacent to a location where a foot portion of the ladder is to rest while the ladder is in use. The base member includes at least one receiver for cooperating with an instantaneously-actuated fastener to instantaneously secure the base member to the mounting surface. A first brace is to be coupled to the ladder and to the base member to extend between the base member and a bottom portion of the ladder while the ladder is propped up against the structure in the climbing orientation. The ladder anchor also includes a second brace with a proximate end to be coupled to the base member and a distal end to be coupled to an upper portion of the ladder that is above the bottom portion when the ladder is propped up against the structure in the climbing orientation. An adjustment apparatus is provided for adjusting a length of at least one of the first and second braces and thereby apply the stabilizing force to the ladder and minimize slippage of the bottom portion of the ladder away from the structure that the ladder is propped up against while in the climbing orientation. The adjustment apparatus can include at least one of, or both: a rough adjuster for rapidly adjusting the length of the at least one of the first and second braces to a distance that is approximately equal to a distance between the base member secured to the mounting surface and the ladder; and a fine adjuster for finely adjusting the length of the at least one of the first and second braces extending between the ladder and the base member.

According to another aspect, the present invention provides a method of stabilizing a ladder propped up against a structure in a climbing orientation. The method includes propping the ladder against the structure with a bottom portion of the ladder further away from the structure than an upper portion of the ladder. A base member is to be secured to a mounting surface adjacent a bottom portion of the ladder with an instantaneously-actuated fastener. First, second and third braces are to be extended between the ladder and the base member. And a length of at least one of the first and second braces is to be adjusted to apply the stabilizing force to the ladder and minimize slippage of the bottom portion of the ladder away from the structure that the ladder is propped up against while in the climbing orientation. The adjustment can include at least one of, or both: rapidly adjusting the length of the first and second braces to a distance that is approximately equal to a distance between the base member secured to the mounting surface and the ladder; and finely adjusting the length of the at least one of the first and second braces extending between the ladder and the base member.

According to another aspect, the present invention provides a ladder anchoring system for applying a stabilizing force on a ladder propped up against a structure in a climbing orientation. The ladder anchoring system includes a base member to be coupled to a mounting surface adjacent to a location where a foot portion of the ladder is to rest while the ladder is in use. The base member includes at least one receiver for cooperating with an instantaneously-actuated fastener to instantaneously secure the base member to the mounting surface when actuated. An instantaneously-actuated fastener comprising a rapidly burning powder propellant enclosed within a shell is also provided, wherein the instantaneously-actuated fastener is to be propelled into the receiver in a single continuous motion by an explosive force generated by ignition of the powder propellant. A first brace is provided to be coupled between the base member and a bottom portion of the ladder in the climbing orientation. Similarly, second and third braces are to be provided to be coupled between the base member and the ladder in the climbing orientation. A transversely extending protrusion is provided adjacent to a distal end of each of the first and second braces to be at least partially inserted into the same, or different hollow rungs of the ladder. An adjustment apparatus is provided for adjusting a length of at least one of the first and second braces and thereby impart the stabilizing force on to the ladder and minimize slippage of the bottom portion of the ladder away from the structure that the ladder is propped up against while in the climbing orientation.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of a ladder anchoring system providing a stabilizing force on a ladder according to an embodiment of the present invention;

FIG. 2 is a front view of a ladder anchoring system providing a stabilizing force on a ladder according to an embodiment of the present invention;

FIG. 3 is a front view of a ladder anchor without a ladder according to one embodiment of the present invention;

FIG. 4 is a top view of a base member according to an aspect of the present invention, the base member including a plurality of receivers for receiving an instantaneously-actuated fasteners;

FIG. 5 is a top view of a base member according to an aspect of the present invention, the base member including a plurality of receivers and a plurality of compatible clips for receiving an instantaneously-actuated fasteners and coupling the base member to a mounting surface;

FIG. 6 is a partial cutaway view of the base member of FIG. 5 taken along line 6-6; and

FIG. 7 is a top view of a base member according to an aspect of the present invention, the base member supporting a plurality of instantaneously-actuated fasteners adjacent to compatible receivers and including a backstop and a plurality of steps on which a user can stand to minimize a loss of force during actuation of the instantaneously-actuated fasteners due to recoil.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

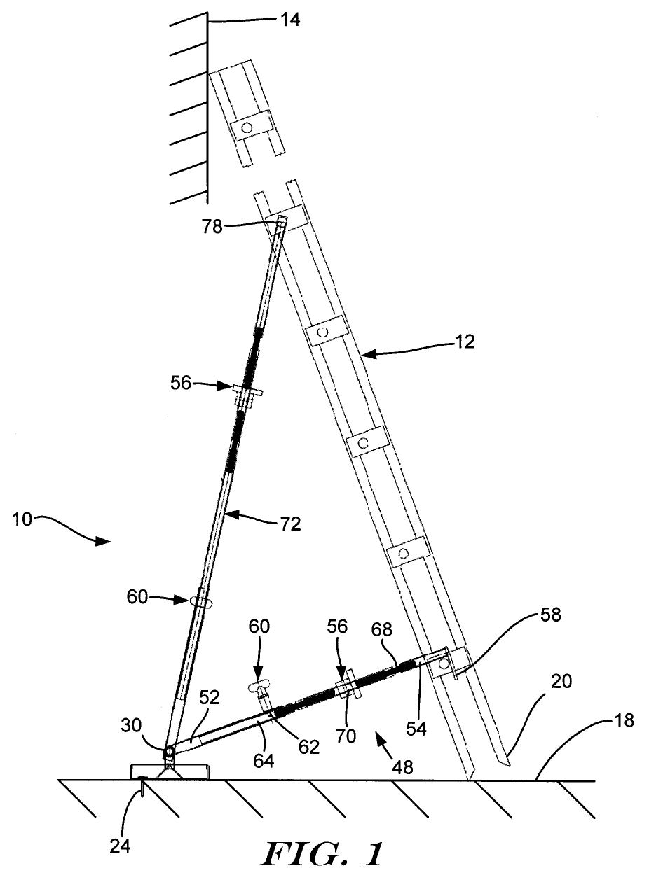

A ladder anchoring system 10 for applying a stabilizing force on a ladder 12 propped up against a structure 14 in a climbing orientation is schematically illustrated in FIG. 1. As shown, the ladder anchoring system 10 includes a base member 16 to be coupled to a mounting surface 18 adjacent to a location where a bottom portion 20 of the ladder 12 is to rest while the ladder 12 is in use. The base member 16 can be formed from any suitably durable and strong material to withstand the forces imparted thereon when employed to stabilize the ladder 12. For example, the base member 16 can be stamped from a metal plate, molded or forged metal, or heavy gauge polymeric material that can withstand the forces imparted thereon when employed to stabilize the ladder 12 without fracturing.

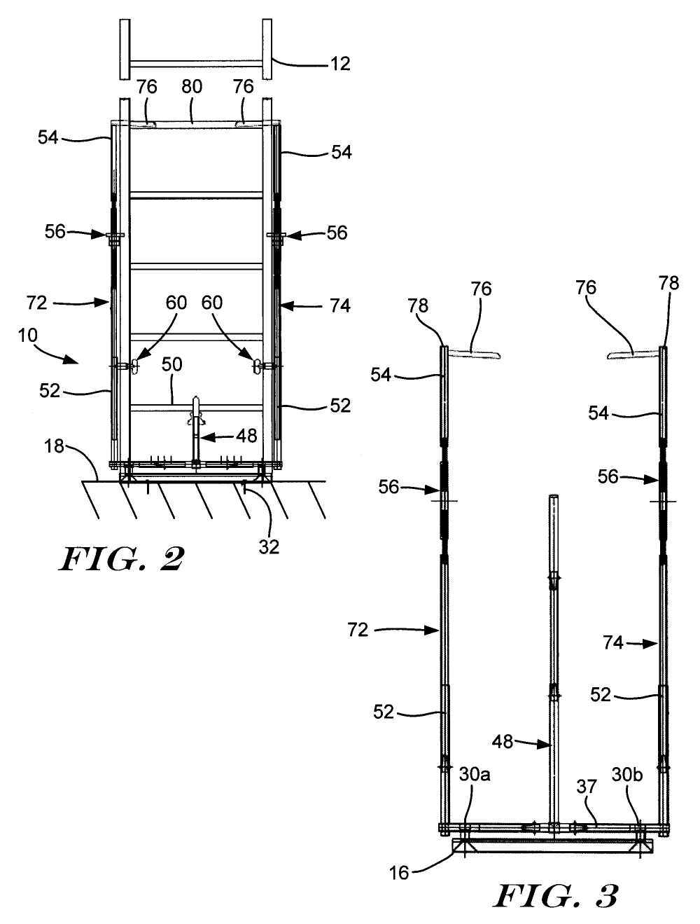

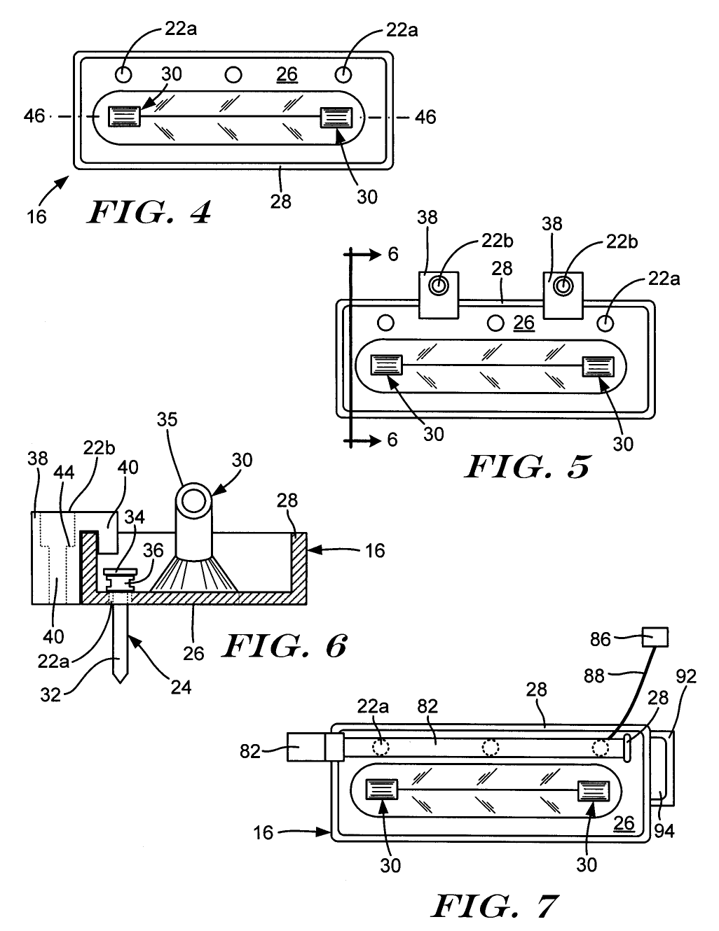

The base member 16, shown in a partial cutaway view in FIG. 6, includes a substantially planar bottom portion 26 that is to rest on a concrete ground surface or other suitable mounting surface 18 such as a brick wall, for example. A peripheral side wall 28 defines a perimeter of the base member 16 and gives the base member 16 a substantially U-shaped appearance in the cutaway view from the side shown in FIG. 6. A pair of pivotal brace mounts 30a, 30b are supported above the bottom portion 26 and within the periphery of the base member 16 defined by side wall 28. Each brace mount 30a, 30b can cooperate with a proximate end of an adjustable brace that also includes a distal end that can be coupled to the ladder 12 to impart the stabilizing force thereon as described below. The brace mounts 30a, 30b are said to be pivotal because it allows for pivoting of the braces coupled thereto about axis 46-46 (FIG. 4). For example, each brace mount 30, 30b can optionally include an annular hinge frame 35 that receives a hinge pin 37 (FIGS. 2 and 3) also extending through a similar hinge frame provided adjacent a proximate end of first, second and third braces 48, 72 and 74, respectively, as described below.

Regardless of the material used to form the base member 16, the base member can include at least one receiver, such as receiver 22a (FIGS. 4-6) and receiver 22b (FIG. 5-6) for example. Each receiver 22a, 22b can receive and cooperate with an instantaneously-actuated fastener 24 to instantaneously secure the base member 16 to the mounting surface 18 when the instantaneously-actuated fastener 24 is actuated. The receiver 22a can be an aperture formed in the bottom portion 26, or any other portion of the base member 16. Thus, when the instantaneously-actuated fastener 24 is actuated an elongated projectile portion 32 of the instantaneously-actuated fastener 24 extends through the receiver 22a, and is at least partially inserted into the mounting surface 18 to secure the base member 16 to the mounting surface 18.

With the instantaneously-actuated fastener 24 received by the receiver 22a, a head 34 of the instantaneously-actuated fastener 24 is separated from the bottom portion 26 of the base member 16 by an annular spacer 36 that can be placed as a sleeve around a portion of the elongated projectile portion 32. The spacer 36 can be formed from a plastic or other suitably durable material that can be partially deformed when the instantaneously-actuated fastener 24 is actuated. The distance between the head 34 and the bottom portion 26 of the base member 16 is sufficient to allow for insertion of a crow bar, claw hammer, or other suitable tool (not shown) to facilitate removal of the elongated projectile portion 32 of the instantaneously-actuated fastener 24 from the mounting surface 18 when ladder stabilization is no longer needed.

According to alternate embodiments, the receiver 22b can include an aperture defined by a clip 38 with a hook portion 40 that is to be placed over the side wall 28 of the base member 16 to secure the base member 16 to the concrete ground surface or other mounting surface 18, also as shown in FIGS. 5 and 6. The hook portion 40 of the clip 38 defines a notch in the clip 38 that receives an upper portion of the side wall 28. The instantaneously-actuated fastener 24 can be actuated to insert the elongated projectile portion 32 through the receiver 22b and an interior passage 42 defined by the clip 38 before extending at least partially into the mounting surface 18. The head 34 and optional spacer 36 can impart a force onto a flange 44 formed in the interior passage 42 of the receiver 22b to secure the clip 38, and accordingly, the base member 16 to the mounting surface 18. Thus, if the receiver 22b or other portion of the clip 38 is damaged during use, or if the instantaneously-actuated fastener 24 is not secured in the mounting surface 18 on the first attempt to do so, the clip 38 can be replaced and/or moved to a different location along the periphery of the base member 16 defined by the side wall 28. Further, additional clips 38 can be hooked onto the side wall 28 as needed.

The instantaneously-actuated fastener 24 can be powder actuated, pneumatically actuated, or actuated by any other suitable driving force that can drive the elongated projectile portion 32 into the mounting surface 18 substantially instantaneously upon being actuated, optionally in a single stroke. For example, according to one embodiment, the instantaneously-actuated fastener 24 can include a rapidly burning powder propellant enclosed within a shell between the shell and the head 34. The elongated projectile portion 32 of the instantaneously-actuated fastener 24 is propelled into the receiver 22a or 22b in a single continuous motion by an explosive force generated by ignition of the powder propellant in a manner analogous to the manner in which a bullet is discharged from a firearm. According to another embodiment, for example, a piston provided in a chamber of a fastener installation tool (not shown) is acted on by the ignited powder propellant. The propellant acts on the piston, which in turn drives the elongated projectile portion 32 into the mounting surface 18. Ignition of the powder propellant can be accomplished through the use of any suitable fastener installation tool, and the instantaneously-actuated fastener 24 can be high velocity, or more preferably low velocity fasteners where the elongated projectile portion 32 does not exceed 492 feet per second during installation.

The instantaneously-actuated fastener 24 can also be any other fastener that can be installed substantially instantaneously upon being actuated, and optionally in a single stroke. According to another embodiment, the instantaneously-actuated fastener 24 can be pneumatically installed. A high pressure gas such as compressed air, for example, could be discharged in a pulse to drive the elongated projectile portion 32 of the instantaneously-actuated fastener 24 into the mounting surface 18.

Once the base member 16 is secured to the mounting surface 18 as shown in FIG. 1, one or more, and optionally three braces are to be coupled between the base member 16 and the ladder 12 propped against the structure 14 in the climbing orientation. A first brace 48 is to be coupled between a central portion of the base member 16 and a bottom portion of the ladder 12 with the ladder 12 in the climbing orientation. A hook 58 at a distal end of the first brace can be hooked onto a lower rung on the ladder 12. For example, the bottom portion of the ladder 12 can be one of the lower rungs, such as the bottom most rung 50 (FIG. 2).

The first brace 48 can include a first rigid segment 52 coupled to a second rigid segment 54 by a fine adjustment mechanism 56 that is operable to finely adjust the overall length of the first brace 48. To “finely adjust” the overall length of the first brace 48 means to adjust the separate between the first and second rigid segments 52, 54 a short distance with a mechanical device once the length of the first brace 48 has been manually “roughly adjusted” to approximate the distance between the base member 16 and the bottom portion of the ladder 12 to which the first brace 48 is coupled. While rough adjustment allows for a rapid, wide range of adjustment during a given adjustment to quickly approximating the length between the base member 16 and the bottom portion of the ladder 12, finely adjusting the length of the first brace 48 is a relatively short length adjustment to establish a suitable tension on the first brace to stabilize the ladder 12. The first brace can also minimize slippage of the bottom portion of the ladder 12 away from the structure 14.

In FIG. 1, the first brace 48 also includes a rough adjustment mechanism 60 in the form of a locking pin 62 and a series of apertures that allow the locking pin 62 to be inserted at least partially into the first rigid segment 52 and a telescopically adjustable inner segment 64 at various locations. To roughly adjust the length of the first brace 48, a handle 65 coupled to the locking pin 62 can be pulled to extract the locking pin 62 from an aperture in at least one of the first rigid segment 52 and the inner segment 64. Once the locking pin 62 has cleared at least one of the segments 52, 64, the inner segment 64 can be telescopically adjusted relative to the first rigid segment 52. Once the length of the first brace 48 is approximately the same length as the distance between the base member 18 and the bottom portion of the ladder 12, the handle 65 can be release, allowing the locking pin 62 to return through a corresponding aperture under an urging force from a spring, for example.

Once the length of the first brace 48 is finally adjusted, the adjusted length can optionally be locked in place through a locking mechanism, or held firm by the fine adjustment mechanism 56 itself. For instance, the fine adjustment mechanism itself shown in FIG. 1 can optionally include a turnbuckle comprising an externally-threaded shaft 68 coupled between the first and second rigid 52, 54 segments, and a sleeve 70 comprising an internally threaded aperture that cooperates with the externally threaded shaft 68 to adjust a distance separating the first and second rigid segments 52, 54.

Alternate embodiments include a rough and fine adjustment mechanism combined into a common adjustment mechanism. Examples of the common adjustment mechanism that includes a clasp coupling the first and second rigid segments 52, 54 together. Similar to a quick release that can be used to quickly disconnect a tire from a bicycle, the clasp can be opened to allow the first and second rigid segments 52, 54 to travel freely relative to each other and closed to draw the first and second rigid segments 52, 54 slightly closer together to establish the desired tension on the first brace 48 extending between the ladder 12 and the base member 16. According to other such embodiments, the first brace can be a nylon (or other suitably strong material) strap including a ratcheting or sliding friction locking mechanism such as what is commonly referred to as a “tie down” used to secure cargo in a bed of a truck for transport.

Similarly, a second brace 72 and a third brace 74 can each be coupled between the base member 16 and the ladder 12 in the climbing orientation. As shown in FIGS. 2 and 3, the second and third braces 72, 74, adjacent their distal ends 78, each include a transversely extending protrusion 76 that is to be at least partially inserted into a hollow rung 80 of the ladder. Also similar to the first brace 48, the second and third braces 72, 74 can each optionally include at least one of the rough adjustment mechanism 60 and the fine adjustment mechanism 56 operatively disposed between two rigid segments 52, 54. Again the length of the second and third braces 72, 74 can be adjusted as described above with respect to the first brace 48 to establish a suitable tension on the first and second braces 72, 74 to stabilize the ladder 12 while it is propped up against the structure 14 in the climbing orientation.

FIG. 7 shows an alternate embodiment wherein the one or more instantaneously-actuated fasteners 24 are powder-actuated, and as such, comprise a rapidly-burning powder propellant enclosed within a shell that can be ignited to drive the projectile portion 32 into the mounting surface 18 to secure the base member 18 thereto. The instantaneously-actuated fasteners 24 (FIG. 6) is coupled to, and optionally supported by the base member 16 adjacent to a respective receiver 22a (shown as hidden lines) in a suitable position to be actuated. Being coupled to the base member 16 in this manner, the instantaneously-actuated fasteners 24 and the base member 16 collectively form a pre-assembled unit that can be placed at a desired location on the mounting surface 18 with the instantaneously-actuated fasteners 24 already in place and ready to be actuated. Thus, the instantaneously-actuated fasteners 24 can be coupled to the base member 16 even before the base member 16 is placed against the mounting surface 18 adjacent to the location where a foot portion of the ladder 12 is to rest while the ladder 12 is in use. A suitable detonator 86 for igniting the rapidly-burning powder propellant to secure the base member 16 to the mounting surface 18 can optionally be operatively coupled to actuate the instantaneously-actuated fasteners 24. The detonator can be any conventional trigger operatively connected to the instantaneously-actuated fasteners 24 by a detonation cord 88 or the like. The detonator 86 can alternately be an electrical actuation mechanism according to other embodiments.

The embodiment in FIG. 7 also includes a backstop 82 that is pivotally coupled to the base member 16 by a hinge 84. When actuating the instantaneously-actuated fasteners 24 according to the present embodiment, the backstop 82 can be closed to conceal the instantaneously-actuated fasteners 24 aligned with their respective receivers 22a. A first user can step on a tread 90 to hold the backstop 82 tight against the instantaneously-actuated fasteners 24. A second user can step onto a second tread 92 extending from the base member 16, the second tread 92 defining an aperture 94 forming a handle to enable the base member 16 to be easily carried. The instantaneously-actuated fasteners 24 can be actuated with the detonator 86 while the weight of the first and second users on the treads 90, 92 to minimize a loss of the driving force imparted on the projectile portion 32 of the instantaneously-actuated fastener 24 due to recoil.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ladder anchor for applying a stabilizing force on a ladder propped up against a structure in a climbing orientation, the ladder anchor comprising:
a base member to be coupled to a mounting surface adjacent to a location where a foot portion of the ladder is to rest while the ladder is in use, wherein the base member comprises at least one receiver for cooperating with an instantaneously-actuated fastener to instantaneously secure the base member to the mounting surface;
a first brace to be coupled to the ladder and to the base member to extend between the base member and a bottom portion of the ladder while the ladder is propped up against the structure in the climbing orientation;
a second brace comprising a proximate end coupled to the base member and a distal end to be coupled to an upper portion of the ladder that is above the bottom portion when the ladder is propped up against the structure in the climbing orientation;
an adjustment apparatus for adjusting a length of at least one of the first and second braces to apply the stabilizing force to the ladder and minimize slippage of the bottom portion of the ladder away from the structure that the ladder is propped up against while in the climbing orientation, wherein the adjustment apparatus comprises at least one of:
a rough adjuster for rapidly adjusting the length of the at least one of the first and second braces to a distance that is approximately equal to a distance between the base member secured to the mounting surface and the ladder; and
a fine adjuster for fine adjustment of the length of the at least one of the first and second braces extending between the ladder and the base member.

2. The ladder stabilizing system according to claim 1, wherein the receiver is an aperture formed in the base member through which an elongated portion of the instantaneously-actuated fastener extends to be at least partially extended into the mounting surface.

3. The ladder stabilizing system according to claim 1, wherein the instantaneously-actuated fastener encloses a rapidly burning powder propellant enclosed within a shell, wherein the instantaneously-actuated fastener is to be propelled into the receiver in a single continuous motion by an explosive force generated by ignition of the powder propellant.

4. The ladder stabilizing system according to claim 1, wherein the instantaneously-actuated fastener includes a pneumatically-actuated fastener that is to be propelled into the receiver in a single continuous motion by a high-pressure pneumatic discharge.

5. The ladder stabilizing system according to claim 1, wherein the first brace includes a first rigid segment coupled to a second rigid segment by the fine adjustment mechanism to be actuated for establishing a suitable tension on the brace between the ladder and the base member to minimize slippage of the bottom portion of the ladder.

6. The ladder stabilizing system according to claim 5, wherein the fine adjustment mechanism includes a turnbuckle comprising an externally-threaded shaft provided to at least one of the first and second segments, and a sleeve comprising an internally threaded aperture that cooperates with the at least one externally threaded shaft to adjust a distance separating the first and second segments.

7. The ladder stabilizing system according to claim 5, wherein the fine adjustment mechanism includes a clasp coupling the first and second rigid segments together.

8. The ladder stabilizing system according to claim 7, wherein the clasp is openable to allow the first and second rigid segments to travel freely relative to each other and closeable to establish the desired tension on the brace between the ladder and the base member.

9. The ladder stabilizing system according to claim 8, wherein a transversely extending protrusion is provided to a distal end of the second brace, and the transversely extending protrusion at least partially extends into a hollow rung of the ladder.

10. The ladder stabilizing system according to claim 1, wherein the instantaneously-actuated fastener comprises a rapidly-burning powder propellant enclosed within a shell that can be ignited to drive a portion of the instantaneously-actuated fastener into the mounting surface to secure the base member to the mounting surface, and wherein the instantaneously-actuated fastener is supported by the base member adjacent to the receiver in a suitable position to be actuated before the base member is placed against the mounting surface adjacent to the location where a foot portion of the ladder is to rest while the ladder is in use.

11. The ladder stabilizing system according to claim 10 further comprising a detonator for igniting the rapidly-burning powder propellant to secure the base member to the mounting surface.

12. The ladder stabilizing system according to claim 10 further comprising a step on which a user can step before igniting the rapidly-burning powder propellant to minimize a loss of force imparted on the instantaneously-actuated fastener due to recoil.

13. The ladder stabilizing system according to claim 9, wherein at least one of the first and second braces is pivotally coupled to the base.

14. A method of stabilizing a ladder propped up against a structure in a climbing orientation, the method comprising:
propping the ladder against the structure with a bottom portion of the ladder further away from the structure than an upper portion;
securing a base member to a mounting surface adjacent a bottom portion of the ladder with an instantaneously-actuated fastener;
extending a first brace between the ladder and the base member;
extending a second brace between the ladder and the base member;
adjusting a length of at least one of the first and second braces to apply the stabilizing force to the ladder and minimize slippage of the bottom portion of the ladder away from the structure that the ladder is propped up against while in the climbing orientation, wherein the adjusting comprises at least one of:
rapidly adjusting the length of the first and second braces to a distance that is approximately equal to a distance between the base member secured to the mounting surface and the ladder; and
finely adjusting the length of the at least one of the first and second braces extending between the ladder and the base member.

15. The method according to claim 14 further comprising extending a third brace between the ladder and the base member, wherein each of the second and third braces comprises a transversely extending protrusion provided adjacent to a distal end thereof and the steps of extending the second and third braces comprises extending at least a portion of the protrusions of the first and second braces into one or more hollow rungs of the ladder.

16. The method according to claim 14, wherein the step of finely adjusting the length of the at least one of the first and second braces comprises rotating a first threaded portion relative to a second threaded portion provided to the at least one of the first and second braces, wherein the first and second threaded portions threadedly engage each other to shorten the length of the at least one of the first and second braces.

17. A ladder anchoring system for applying a stabilizing force on a ladder propped up against a structure in a climbing orientation, the ladder anchoring system comprising:
a base member to be coupled to a mounting surface adjacent to a location where a foot portion of the ladder is to rest while the ladder is in use, wherein the base member comprises at least one receiver for cooperating with an instantaneously-actuated fastener to instantaneously secure the base member to the mounting surface when actuated;
an instantaneously-actuated fastener comprising a rapidly burning powder propellant enclosed within a shell, wherein the instantaneously-actuated fastener is to be propelled into the receiver in a single continuous motion by an explosive force generated by ignition of the powder propellant;
a first brace to be coupled between the base member and a bottom portion of the ladder in the climbing orientation;
a second brace to be coupled between the base member and the ladder in the climbing orientation, wherein a transversely extending protrusion is provided adjacent to a distal end of the second brace to be at least partially inserted into a hollow rung of the ladder;
a third brace to be coupled between the base member and the ladder in the climbing orientation, wherein a transversely extending protrusion is provided adjacent to a distal end of the third brace to be at least partially inserted into a hollow rung of the ladder; and
an adjustment apparatus for adjusting a length of at least one of the first and second braces to apply the stabilizing force to the ladder and minimize slippage of the bottom portion of the ladder away from the structure that the ladder is propped up against while in the climbing orientation.
